(19) United States
(12) Patent Application Publication
(10) Pub. No.: US 2012/0223793 A1
(43) Pub. Date: Sep. 6, 2012

(54) Inductor having greater current

(75) Inventors: Hang Chun Lu, Hsinchu (TW); Ya Wen Yang, Hsinchu (TW); Hsiu Fa Yeh, Hsinchu (TW); Pin Yu Chen, Hsinchu (TW)

(73) Assignee: Mag. Layers Scientific Technics Co., Ltd.

(21) Appl. No.: 12/932,598

(22) Filed: Mar. 1, 2011

(51) Int. Cl. H01F 27/06

(52) U.S. Cl. 336/65

(57) ABSTRACT

An inductor includes a base member having an upper channel which has a height “H” greater than a width “W” of the upper channel of the base member, a conductive member includes a conductive plate engaged into the upper channel of the base member, and a top member is attached onto the base member and engaged with the base member for solidly retaining the conductive member between the top member and the base member. The conductive member includes one or more side plates extended from the conductive plate for engaging onto the end portion of the base member. The side plate includes an upper panel and a lower panel which has a width “D” greater than a width “d” of the upper panel.

### BACKGROUND OF THE INVENTION

1. Field of the Invention

The present invention relates to an inductor, and more particularly to an inductor including an increased or greater saturation current for allowing the inductor to be suitably used in various kinds of apparatuses or facilities or the like, and including a decreased direct current resistance for facilitating the current flowing through the inductor.

2. Description of the Prior Art

Typical inductors have been developed and provided for inducing the current and comprise one or more cores and one or more coils or conductive members for inducing or generating the current.

For example, U.S. Pat. No. 5,751,203 to Tsutsumi et al., and U.S. Pat. No. 7,042,324 to Watanabe disclose two of the typical inductors each also comprising one or more coils or conductive members engaged into the cores for inducing or generating the current.

However, the typical inductors may only induce or generate a limited current that may not be suitably supplied to do work and that may include an increased or greater direct current resistance such that the generated current may not suitably flow through the typical inductors.

The present invention has arisen to mitigate and/or obviate the afore-described disadvantages of the conventional inductive members or inductors.

### SUMMARY OF THE INVENTION

The primary objective of the present invention is to provide an inductor including an increased or greater saturation current for allowing the inductor to be suitably used in various kinds of apparatuses or facilities or the like.

The other objective of the present invention is to provide an inductor including a decreased direct current resistance for facilitating the current flowing through the inductor.

In accordance with one aspect of the invention, there is provided an inductor comprising a base member including an upper channel formed therein, the upper channel of the base member including a height “H” greater than a width “W” of the upper channel of the base member, a conductive member including a conductive plate engaging into the upper channel of the base member, and a top member attached onto the base member and engaged with the base member.

The conductive member includes at least one side plate extended from the conductive plate for engaging onto an end portion of the base member. The side plate of the conductive member includes an upper panel and a lower panel.

The lower panel includes a width “D” greater than a width “d” of the upper panel. The side plate of the conductive member includes a slit formed between the upper panel and the lower panel.

The conductive member includes an extension extended from the side plate. The base member includes a slot formed therein for engaging with the extension of the side plate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an inductor in accordance with the present invention;

FIG. 2 is a perspective view of the inductor;

FIG. 3 is a cross sectional view of the inductor taken along lines 3-3 of FIG. 2; and

FIG. 4 is a diagram illustrating the saturation current generated by the inductor.

### DETAILED DESCRIPTION OF THE PREFERRED EMBODIMENT

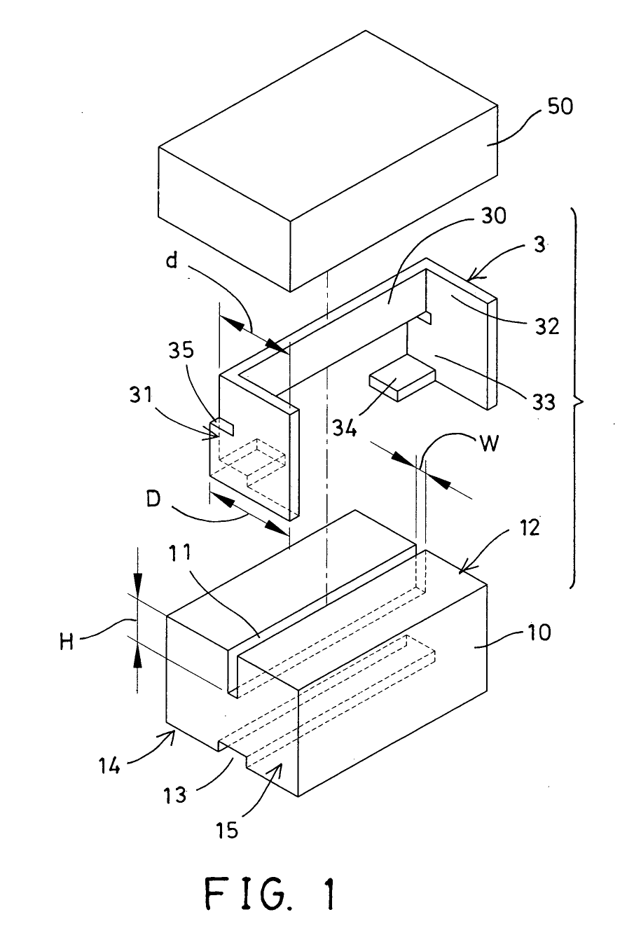

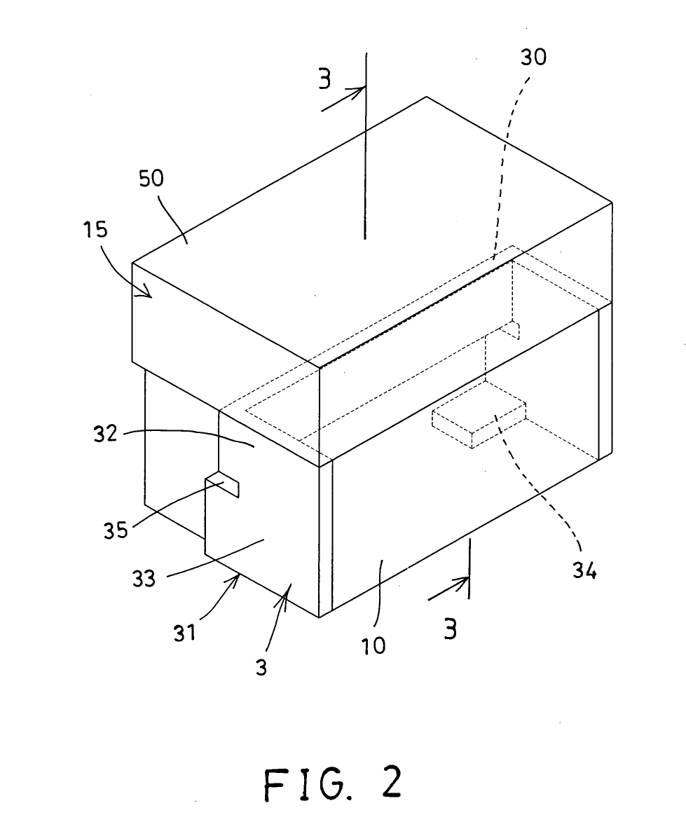

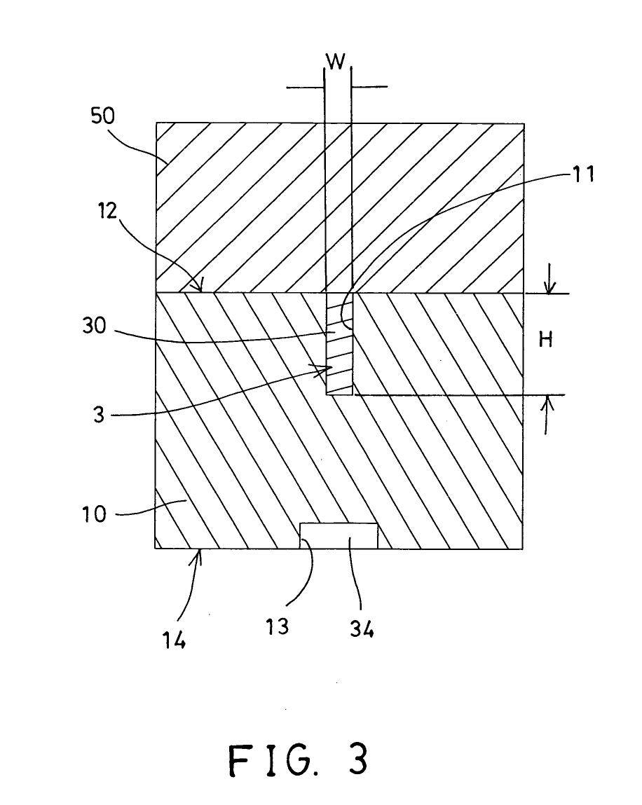

Referring to the drawings, and initially to FIGS. 1-3, an inductor in accordance with the present invention comprises a first or lower core or base member 10 including a longitudinal upper or first groove or channel 11 formed or provided on the upper portion 12 thereof, and including another longitudinal lower or second groove or slot 13 formed or provided on the lower portion 14 thereof, in which the upper channel 11 of the base member 10 includes a depth or height “H” greater than the width “W” of the upper channel 11 of the base member 10. The lower slot 13 of the base member 10 preferably, but not necessarily includes a depth or height smaller than the width of the lower slot 13 of the base member 10.

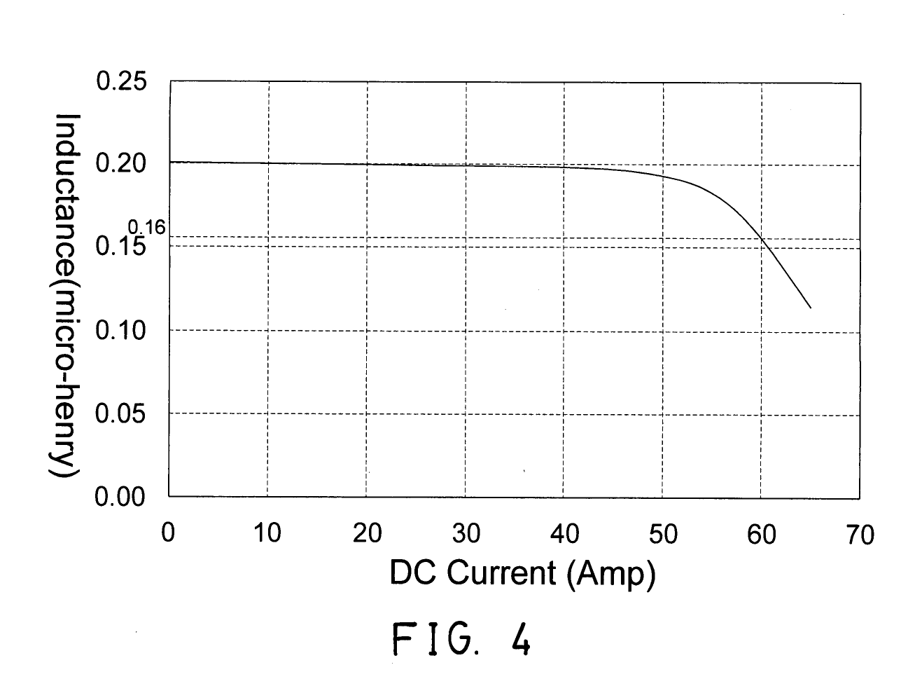

A conductive member 3 is further provided and includes a central linking conductive plate 30 having a size or dimension for snugly fitting or attaching or mounting or engaging into the upper channel 11 of the base member 10 for suitably increasing the saturation current and for allowing the inductor to be suitably used in various kinds of apparatuses or facilities or the like. For example, as shown in FIG. 4, when the direct current reaches about 60 (sixty) Amps, the inductance will be slightly dropped or decreased from 0.20 to 0.16 micro-henry, that is smaller than 25%, such that the saturation current may be increased or greater than that of the typical inductors.

The conductive member 3 further includes one or more (such as two) side plates 31 disposed or attached or mounted or secured to the side portions of the central linking conductive plate 30 for attaching or mounting or securing or engaging onto the two end portions 15 of the base member 10, and preferably, but not necessarily that the side plates 31 are perpendicular to the central linking conductive plate 30, the side plates 31 of the conductive member 3 each further include an upper panel 32 and a lower panel 33, in which the lower panel 33 includes a length or width “D” greater than the length or width “d” of the upper panel 32 for allowing the area of the side plates 31 of the conductive member 3 to be suitably increased.

For example, the equation for deriving the resistance is: R (resistance)=L (length)/A (area); i.e., the resistance is in inverse ratio relative to the area, such that the resistance will be decreased when the area is increased. After test, the direct current resistance “Rdc” is lower than 0.29 mΩ. The conductive member 3 further includes a terminal or extension 34 extended from each of the side plates 31, such as extended from the lower panel 33 of each of the side plates 31 and engaged into the lower slot 13 of the base member 10 for solidly and stably anchoring or securing or retaining the conductive member 3 to the base member 10.

The inductor in accordance with the present invention further comprises a cover or second or top member 50 disposed or attached or mounted or secured onto the base member 10 and contacted or engaged with the conductive member 3 for solidly and stably anchoring or securing or retaining the conductive member 3 between the top member 50 and the base member 10. It is preferable, but not necessarily that the conductive member 3 further includes a cut off portion or notch or slit 35 formed between the upper panel 32 and the lower panel 33 for suitably separating the upper panel 32 and the lower panel 33 from each other.

Accordingly, the inductor in accordance with the present invention includes an increased or greater saturation current for allowing the inductor to be suitably used in various kinds of apparatuses or facilities or the like, and including a decreased direct current resistance for facilitating the current flowing through the inductor.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An inductor comprising:
a base member including an upper channel formed therein, said upper channel of said base member including a height “H” greater than a width “W” of said upper channel of said base member,
a conductive member including a conductive plate engaged into said upper channel of said base member, and
a top member attached onto said base member and engaged with said base member.

2. The inductor as claimed in claim 1, wherein said conductive member includes at least one side plate extended from said conductive plate for engaging onto an end portion of said base member.

3. The inductor as claimed in claim 2, wherein said at least one side plate of said conductive member includes an upper panel and a lower panel.

4. The inductor as claimed in claim 3, wherein said lower panel includes a width “D” greater than a width “d” of said upper panel.

5. The inductor as claimed in claim 3, wherein said at least one side plate of said conductive member includes a slit formed between said upper panel and said lower panel.

6. The inductor as claimed in claim 2, wherein said conductive member includes an extension extended from said at least one side plate.

7. The inductor as claimed in claim 6, wherein said base member includes a slot formed therein for engaging with said extension of said at least one side plate.
